(19) United States
(12) Patent Application Publication
(10) Pub. No.: US 2025/0271838 A1
(43) Pub. Date: Aug. 28, 2025

(54) CONTROL DEVICE AND METHOD

(71) Applicant: TOYOTA JIDOSHA KABUSHIKI KAISHA, Toyota-shi (JP)

(72) Inventors: Go INOUE, Gotemba-shi (JP); Yuki Okamoto, Ebina-shi (JP); Kento Ohara, Nisshn-shi (JP); Daiki Yokoyama, Miyoshi-shi (JP); Kento Iwahori, Nagoya-shi (JP); Yasuhiro Saito, Toyoake-shi (JP)

(73) Assignee: TOYOTA JIDOSHA KABUSHIKI KAISHA, Toyota-shi (JP)

(21) Appl. No.: 18/967,671

(22) Filed: Dec. 4, 2024

(30) Foreign Application Priority Data
Feb. 28, 2024 (JP) 2024-028408

(51) Int. Cl. G05B 19/418

(52) U.S. Cl. CPC G05B 19/41805; G05B 2219/31001; G05B 2219/40111

(57) ABSTRACT

The control device manages a process of a mobile body manufactured through a plurality of processes. The plurality of steps includes a first process relating to inspection, an assembling process, an adjustment, and a second process. The control device includes: an acquisition unit that acquires information indicating a state of the mobile body; a determination unit that determines whether adjustment is necessary and whether or not the second process is necessary according to a result of the first process using the information; and a management unit that performs or does not perform the second process or does not perform the adjustment according to the determination.

### CROSS-REFERENCE TO RELATED APPLICATION

This application claims priority to Japanese Patent Application No. 2024-028408 filed on Feb. 28, 2024, incorporated herein by reference in its entirety.

### BACKGROUND

### 1. Technical Field

The present disclosure relates to a control device and a method.

### 2. Description of Related Art

Japanese Unexamined Patent Application Publication (Translation of PCT Application) No. 2017-538619 (JP 2017-538619 A) describes a vehicle that is an object to be manufactured and that travels through remote control or autonomous control, in a manufacturing process for manufacturing vehicles.

### SUMMARY

In the manufacturing process, a vehicle in an unfinished state may be caused to travel so that the vehicle in an unfinished state is moved between a plurality of processes. Since components are gradually assembled to the vehicle in an unfinished state, similar inspections may be performed on the vehicle in the processes. There has been a demand for a technique of further improving the efficiency of the manufacturing process in such a case. The present disclosure can be implemented in the following aspects.
(1) A first aspect of the present disclosure provides a control device that manages a process for a mobile body manufactured through a plurality of processes.
The control device includes:
an acquisition unit that acquires information that indicates a state of the mobile body;
a determination unit that makes a determination as to necessity of adjustment and necessity of a second process according to a result of a first process performed using the information; and
a management unit that performs or does not perform the adjustment and performs or does not perform the second process according to the determination.
The processes include a first process related to inspection, an assembly process performed after the first process to assemble a component to the mobile body, adjustment performed after the first process or the assembly process, and a second process related to inspection and performed after the assembly process or the adjustment.
According to this aspect, the adjustment is omitted when the adjustment can be omitted, and the second process is omitted when the second process can be omitted. Therefore, it is possible to reduce the number of man-hours compared with the case where the adjustment and the second process are performed. In addition, the second process is omitted when the second process can be omitted according to the result of the first process performed using the information indicating the state of the mobile body, and thus it is possible to achieve both the maintenance of the quality and the improvement in the efficiency of the manufacturing process.
(2) In the control device according to the above aspect,
the first process may be performed on the mobile body in a state of a platform; and
the second process may be performed on the mobile body in a state of a finished vehicle.
(3) In the control device according to the above aspect,
the second process may include inspection that is the same as inspection included in the first process.
According to this aspect, it is possible to improve the efficiency of the manufacturing process by omitting the execution of duplicate inspections when the same inspection is performed on the mobile body in a plurality of processes.
(4) In the control device according to the above aspect,
the mobile body may be a mobile body that travels in a factory in which the processes are performed;
the processes may further include a moving process performed after the first process or the assembly process to move the mobile body; and
the management unit may perform the moving process with or without performing the adjustment and with or without performing the second process according to the determination.
(5) A second aspect of the present disclosure provides a method of managing a process for a mobile body manufactured through a plurality of processes.
The method includes:
acquiring information that indicates a state of the mobile body;
making a determination as to necessity of the adjustment and necessity of the second process according to a result of the first process performed using the information; and
performing or not performing the adjustment and performing or not performing the second process according to the determination.

The processes include a first process related to inspection, an assembly process performed after the first process to assemble a component to the mobile body, adjustment performed after the first process or the assembly process, and a second process related to inspection and performed after the assembly process or the adjustment. According to this aspect, the adjustment is omitted when the adjustment can be omitted, and the second process is omitted when the second process can be omitted. Therefore, it is possible to reduce the number of man-hours compared with the case where the adjustment and the second process are performed. In addition, the second process is omitted when the second process can be omitted based on the result of the first process, and thus it is possible to achieve both the maintenance of the quality and the improvement in the efficiency of the manufacturing process.

The present disclosure can be implemented in various forms, and can be implemented in the form of a remote control system, a vehicle control device, a remote autonomous driving method, a vehicle manufacturing method, and the like, for example.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram illustrating a configuration of a system according to a first embodiment;

FIG. 2 is a block diagram illustrating a schematic configuration of the system;

FIG. 3 is a flowchart illustrating a processing procedure of travel control of the vehicle according to the first embodiment;

FIG. 4 is a flowchart illustrating a processing procedure according to the first pre-travel inspection in the first embodiment;

FIG. 5 is a flowchart illustrating a processing procedure according to the second pre-travel inspection in the first embodiment;

FIG. 6 is an explanatory diagram illustrating a schematic configuration of a system according to a second embodiment;

FIG. 7 is a flowchart illustrating a processing procedure of travel control of the vehicle according to the second embodiment;

FIG. 8 is a flow chart showing a process sequence of the first pre-travel test according to the second embodiment; and

FIG. 9 is a flowchart illustrating a processing procedure related to the second pre-travel inspection in the second embodiment.

### DETAILED DESCRIPTION OF EMBODIMENTS

### A. First Embodiment

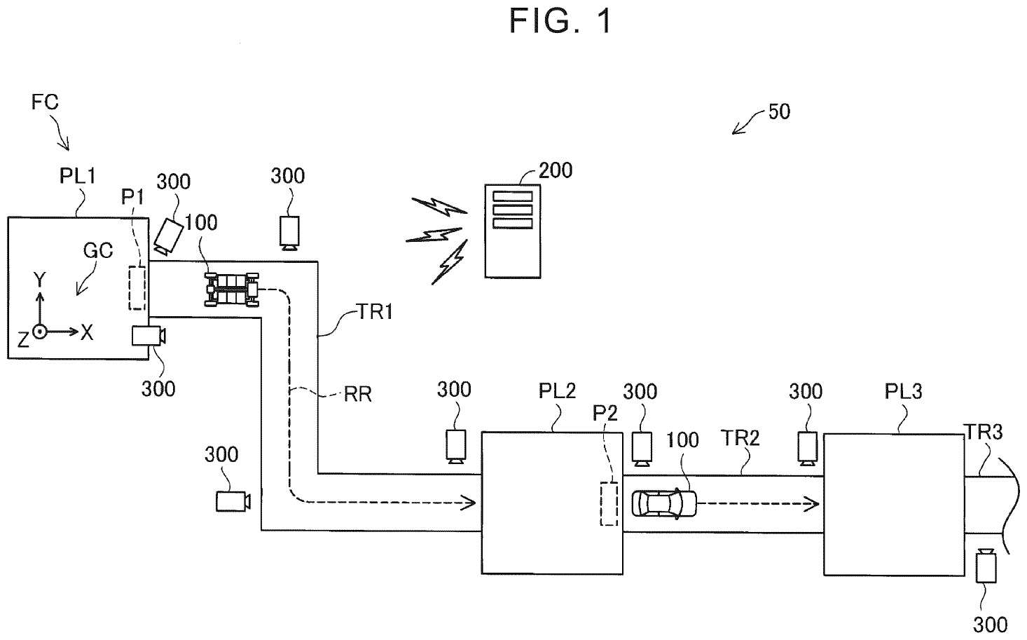

FIG. 1 is a conceptual diagram illustrating a configuration of a system 50 according to a first embodiment. In a factory FC for manufacturing a mobile body, the system 50 is used to move the vehicle 100, which is a mobile body, by unmanned driving. The system 50 includes one or more vehicles 100, a server 200, and a plurality of external sensors 300. Vehicles 100 are Battery Electric Vehicle (BEV).

In the present disclosure, “mobile body” means a movable object, and is, for example, a vehicle or an electric vertical takeoff and landing machine (a so-called flying vehicle). The vehicle may be a vehicle traveling by a wheel or a vehicle traveling by an infinite track, and is, for example, a passenger car, a truck, a bus, a two-wheeled vehicle, a four-wheeled vehicle, a tank, a construction vehicle, or the like. Vehicles include BEV, gasoline-powered vehicles, hybrid electric vehicle, and fuel cell electric vehicle. When the mobile body is other than the vehicle, the expressions of “vehicle” and “vehicle” in the present disclosure can be appropriately replaced with “mobile body”, and the expression of “traveling” can be appropriately replaced with “moving”.

The vehicle 100 is configured to be able to travel by unmanned driving. The term “unmanned driving” means driving that does not depend on the traveling operation of the passenger. The traveling operation means an operation related to at least one of “running”, “turning”, and “stopping” of the vehicle 100. The unmanned driving is realized by automatic or manual remote control using a device located outside the vehicle 100 or by autonomous control of the vehicle 100. A passenger who does not perform the traveling operation may be on the vehicle 100 traveling by the unmanned driving. The passenger who does not perform the traveling operation includes, for example, a person who is simply seated on the seat of the vehicle 100 and a person who performs a work different from the traveling operation such as an assembling operation, an inspection operation, and an operation of switches while riding on the vehicle 100. Driving by the traveling operation of the occupant is sometimes referred to as “manned driving”.

Herein, “remote control” includes “full remote control” in which all of the operations of the vehicle 100 are completely determined from the outside of the vehicle 100, and “partial remote control” in which a part of the operations of the vehicle 100 is determined from the outside of the vehicle 100. Also, “autonomous control” includes “full autonomous control” and “partial autonomous control”. In the “fully autonomous control”, the vehicle 100 autonomously controls its own operation without receiving any information from a device external to the vehicle 100. In “partial autonomous control”, the vehicle 100 autonomously controls its own operation using information received from a device outside the vehicle 100.

The reference coordinate system of the factory FC is a global coordinate system GC, and any position in the factory FC can be represented by the coordinates of X, Y, Z in the global coordinate system GC. The factory FC includes a first location PL1, a second location PL2, and a third location PL3. The first location PL1 and the second location PL2 are connected by a track TR1 on which the vehicles 100 can travel. The second location PL2 and the third location PL3 are connected by a track TR2. In the factory FC, a plurality of external sensors 300 are installed along the track TR1, TR2. The positions of the external sensors 300 in the factory FC are adjusted in advance. The vehicles 100 travel through the 30 track TR1 from the first location PL1 to the second location PL2 by unmanned driving. Further, the vehicles 100 travel through the track TR2 from the second location PL2 to the third location PL3.

The vehicle 100 is manufactured through a plurality of processes. Note that a plurality of steps may be performed, and not all of the plurality of steps may be performed. The first location PL1 is a location where an operation of assembling the vehicles 100 is performed. For example, in the first location PL1, an assembling operation of a component is performed by an assembling robotic device (not shown). The vehicles 100 assembled at the first location PL1 are in a state in which they can travel by unmanned driving, in other words, in a state in which they can perform three functions of “running”, “turning”, and “stopping” by unmanned driving. In the present embodiment, the vehicle 100 assembled at the first location PL1 travels from the first location PL1 to the second location PL2 by unmanned driving in the form of a platform with the configuration described below. Specifically, the vehicle 100 may include at least a vehicle control device and an actuator group in order to perform three functions of “running,” “turning,” and “stopping” by unmanned driving. When the vehicle 100 acquires information from the outside for unmanned driving, the vehicle 100 may further include a communication device. That is, in the vehicle 100 that can be moved by the unmanned driving, at least a part of the interior components such as the driver's seat and the dashboard may not be mounted, at least a part of the exterior components such as the bumper and the fender may not be mounted, and the body shell may not be mounted. In this case, the remaining components such as the body shell may be attached to the vehicle 100 until the vehicle 100 is shipped from the factory FC, or the remaining components such as the body shell may be attached to the vehicle 100 after the vehicle 100 is shipped from the factory FC while the remaining components such as the body shell are not attached to the vehicle 100. Each of the components may be mounted from any direction, such as the upper side, lower side, front side, rear side, right side or left side of the vehicle 100, each may be mounted from the same direction, or may be mounted from a different direction.

In the second location PL2, the components are further assembled to the vehicles 100 by an assembly robotic device (not shown). In the second location PL2, an interior component such as a body shell, a vehicle body such as a bonnet, a seat, a dashboard, and the like, an exterior component such as a bumper, a fender, and the like are assembled to the vehicle 100 in the form of a platform by an assembly robot (not shown). Further, at the second location PL2, a feature is attached. The functional unit is, for example, a plurality of Electronic Control Unit (ECU). In the second location PL2, the vehicle 100 to which the functional unit is attached is in the form of a finished vehicle. The vehicles 100 move from the second location PL2 to the third location PL3 by unmanned driving.

In the third location PL3, the vehicles 100 that are in the condition of the finished vehicle prior to shipping are inspected. In the present embodiment, the inspection performed at the third location PL3 differs from the first pre-travel inspection and the second pre-travel inspection described later. The vehicle 100 that has been inspected is moved to a completed vehicle yard (not shown) through the runway TR3 by unmanned driving.

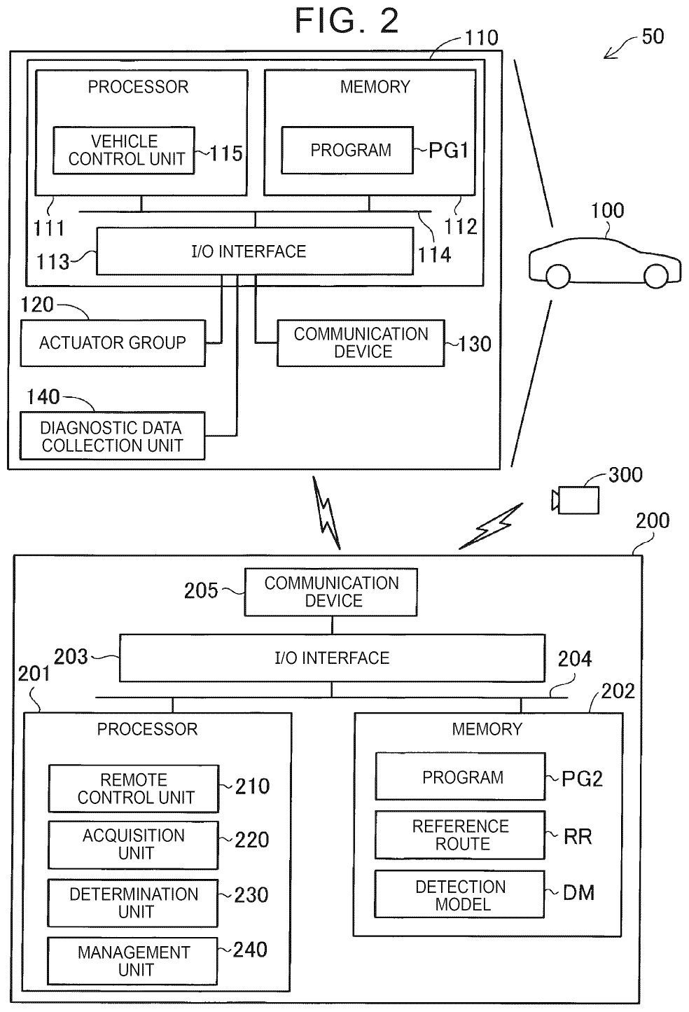

FIG. 2 is a block diagram illustrating a schematic configuration of the system 50. The vehicle 100 includes a vehicle control device 110 for controlling each unit of the vehicle 100, an actuator group 120 including one or more actuators driven under the control of the vehicle control device 110, a communication device 130 for wirelessly communicating with an external device such as the server 200, and a diagnostic data collection unit 140.

The vehicle control device 110 includes a computer including a processor 111, a memory 112, an input/output interface 113, and an internal bus 114. The processor 111, the memory 112, and the input/output interface 113 are bidirectionally communicably connected via an internal bus 114. An actuator group 120 and a communication device 130 are connected to the input/output interface 113. The processor 111 executes the program PG1 stored in the memory 112 to realize various functions including functions as the vehicle control unit 115.

The vehicle control unit 115 controls the actuator group 120 to cause the vehicle 100 to travel. The vehicle control unit 115 can cause the vehicle 100 to travel by controlling the actuator group 120 using the travel control signal received from the server 200. The travel control signal is a control signal for causing the vehicle 100 to travel. In the present embodiment, the travel control signal includes the acceleration and the steering angle of the vehicle 100 as parameters. In other embodiments, the travel control signal may include the speed of the vehicle 100 as a parameter in place of or in addition to the acceleration of the vehicle 100.

The actuator group 120 includes an actuator of a driving device for accelerating the vehicle 100, an actuator of a steering device for changing a traveling direction of the vehicle 100, and an actuator of a braking device for decelerating the vehicle 100.

The communication device 130 is, for example, a radio communication device connected to a Data Link Connector (DLC provided in the vehicle 100. The vehicle 100 and the server 200 communicate with each other through a diagnostic communication. Diagnostic communication is communication used for fault diagnosis. For example, a diagnostic tool connected to a DLC provided in the vehicle 100 can acquire data from various ECU provided in the vehicle 100 via an in-vehicle network.

The diagnostic data collection unit 140 collects data used for performing diagnosis of an operation state of the vehicle 100. The diagnostic data collection unit 140 is connected to a motor control ECU, transmission ECU, brake ECU, electric parking brake ECU, vehicle control device 110, etc. by an in-vehicle network. The diagnostic data collection unit 140 receives, from each ECU, data indicating the status of each device controlled by each ECU and the detected value of the sensor. Data used for diagnostics are collected from a motor control ECU for controlling an actuator of a drive device, a transmission ECU for controlling a transmission, a brake ECU for controlling an actuator of a brake device, an electric parking brake ECU for controlling an electric parking brake, and the like. Incidentally, in FIG. 2, the motor control ECU, the transmission ECU, the brake ECU, is not shown such as an electric parking brake ECU. The function of the diagnostic data collection unit 140 is realized by a diagnostic ECU. The data collected by the diagnostic data collection unit 140 is transmitted to the server 200 via the communication device 130.

The server 200 includes a computer including a processor 201, a memory 202, an input/output interface 203, and an internal bus 204. The processor 201, the memory 202, and the input/output interface 203 are bidirectionally communicably connected via an internal bus 204. A communication device 205 for communicating with various devices external to the server 200 is connected to the input/output interface 203. The communication device 205 can communicate with the vehicle 100 by wireless communication, and can communicate with each external sensor 300 by wired communication or wireless communication. The processor 201 executes the program PG2 stored in the memory 202 to realize various functions including functions as the remote control unit 210, the acquisition unit 220, the determination unit 230, and the management unit 240.

The remote control unit 210 acquires a detection result by the sensor, generates a travel control signal for controlling the actuator group 120 of the vehicle 100 using the detection result, and transmits a travel control signal to the vehicle 100 to cause the vehicle 100 to travel by remote control. The remote control unit 210 may generate and output not only a travel control signal but also a control signal for controlling various accessories provided in the vehicle 100 and actuators for operating various kinds of equipment such as a wiper, a power window, and a lamp. That is, the remote control unit 210 may operate the various types of equipment and the various accessories by remote control.

In the present embodiment, the first pre-travel inspection is performed on the vehicle 100 before the vehicle 100 assembled in the first location PL1 starts traveling toward the second location PL2. The first pre-travel inspection inspects whether or not the vehicle 100 satisfies a necessary condition for traveling. In the first pre-travel inspection, the vehicle 100 is inspected for one or more inspection items. The first pre-travel inspection is performed on the stopped vehicle 100. The first pre-travel inspection is also referred to as “first processing related to inspection”. Also, a second pre-travel inspection may be performed on the vehicle 100 before the vehicle 100 in the form of a completed vehicle at the third location PL3 starts traveling toward the inspection site, for example. The second pre-traveling inspection is for inspecting whether or not the vehicle 100 satisfies a necessary condition for traveling. In the second pre-travel inspection, the vehicle 100 is inspected for one or more inspection items. The second pre-running inspection is also referred to as the “second processing related to inspection”.

Here, it is assumed that the second pre-travel inspection includes the same inspection item as the inspection item included in the first pre-travel inspection. The case where the second pre-travel inspection includes the same inspection item as the inspection item included in the first pre-travel inspection is any of the following cases. The present embodiment corresponds to the following case (i).
(i) The inspection item of the first pre-travel inspection and the inspection item of the second pre-travel inspection are completely in agreement.
(ii) The first pre-travel inspection includes all inspection items of the second pre-travel inspection.

The acquisition unit 220 acquires the data collected by the diagnostic data collection unit 140. The determination unit 230 determines whether or not adjustment is necessary and whether or not the second pre-travel inspection is necessary, using the data collected by the diagnostic data collection unit 140. The management unit 240 manages the adjustment, the execution of the second pre-travel inspection, and the moving process of the vehicle 100 in accordance with the determination by the determination unit 230. The server 200 is also referred to as a “control device”.

The external sensor 300 is a sensor located outside the vehicle 100. The external sensor 300 in the present embodiment is a sensor that captures the vehicle 100 from the outside of the vehicle 100. The external sensor 300 includes a communication device (not shown), and can communicate with another device such as the server 200 by wired communication or wireless communication. Specifically, the external sensor 300 is constituted by a camera. The camera as the external sensor 300 captures an image of the vehicle 100 and outputs a captured image as a detection result.

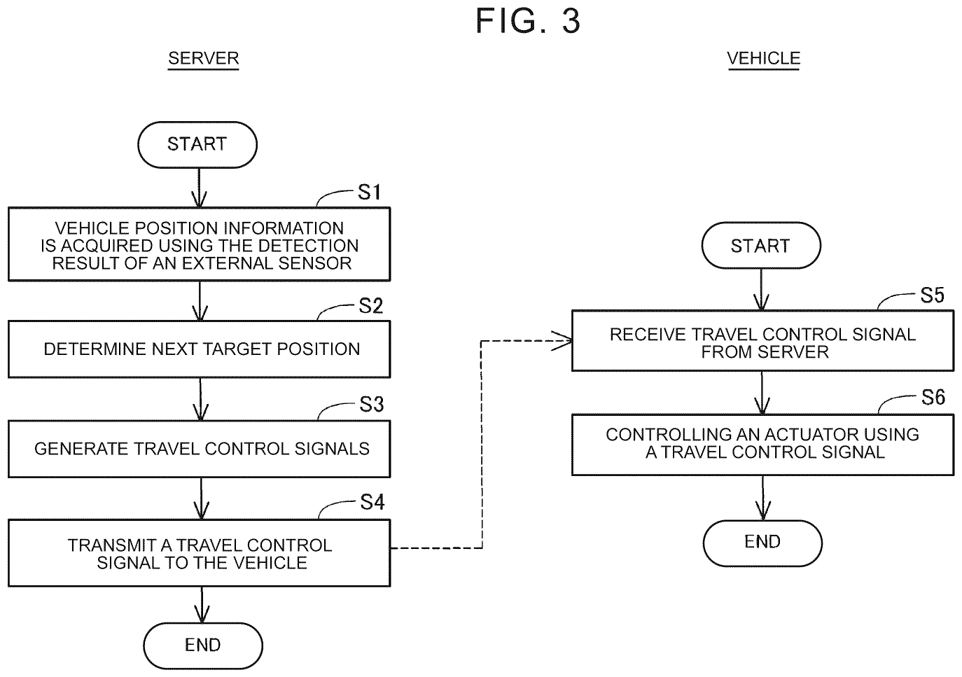

FIG. 3 is a flowchart illustrating a processing procedure of travel control of the vehicle 100 according to the first embodiment. The process of FIG. 3 is executed by the processor 201 of the server 200 functioning as the remote control unit 210 and the processor 111 of the vehicle 100 functioning as the vehicle control unit 115. For example, the process illustrated in FIG. 3 is repeatedly executed at predetermined time intervals from the time when the vehicle 100 starts traveling by remote control.

In step 1, the processor 201 of the server 200 acquires the vehicle position information using the detection result output from the external sensor 300. The vehicle position information is position information that is a basis for generating a travel control signal. In the present embodiment, the vehicle position information includes the position and orientation of the vehicle 100 in the global coordinate system GC of the factory FC. Specifically, in step 1, the processor 201 acquires the vehicle position information using the captured image acquired from the camera which is the external sensor 300.

Specifically, in step 1, the processor 201 acquires the position of the vehicle 100 by, for example, detecting the outline of the vehicle 100 from the captured image, calculating the coordinate system of the captured image, that is, the coordinates of the positioning point of the vehicle 100 in the local coordinate system, and converting the calculated coordinates into the coordinates in the global coordinate system GC. The outline of the vehicle 100 included in the captured image can be detected by, for example, inputting the captured image into a detection model DM using artificial intelligence. The detection model DM is prepared in the system 50 or outside the system 50, for example, and stored in the memory 202 of the server 200 in advance. Examples of the detection model DM include a learned machine learning model that is learned so as to realize one of semantic segmentation and instance segmentation. As the machine learning model, for example, a convolutional neural network (hereinafter referred to as a CNN) learned by supervised learning using a learning dataset can be used. The training data set includes, for example, a plurality of training images including the vehicle 100 and a label indicating which of the regions in the training image indicates the vehicle 100 and the regions other than the vehicle 100. When CNN is learned, the parameters of CNN are preferably updated by back propagation so as to reduce the error between the output-result and-label due to the detection model DM. Further, the processor 201 can obtain the direction of the vehicle 100 by estimating the direction of the movement vector of the vehicle 100 calculated from the position change of the feature point of the vehicle 100 between the frames of the captured image using, for example, the optical flow method.

In step 2, the processor 201 of the server 200 determines the target position to which the vehicle 100 should be heading next. In the present embodiment, the target position is represented by the coordinates of X, Y, Z in the global coordinate system GC. In the memories 202 of the servers 200, reference route RR that is a route on which the vehicles 100 should travel is stored in advance. The route is represented by a node indicating a starting point, a node indicating a passing point, a node indicating a destination, and a link connecting the respective nodes. The processor 201 uses the vehicle position information and the reference route RR to determine the target position to which the vehicle 100 is to be directed next. The processor 201 determines the target position on the reference route RR ahead of the current position of the vehicles 100.

In step 3, the processor 201 of the server 200 generates a travel control signal for causing the vehicle 100 to travel toward the determined target position. The processor 201 calculates the traveling speed of the vehicle 100 from the transition of the position of the vehicle 100, and compares the calculated traveling speed with the target speed. The processor 201 generally determines the acceleration so that the vehicle 100 accelerates when the travel speed is lower than the target speed, and determines the acceleration so that the vehicle 100 decelerates when the travel speed is higher than the target speed. Further, the processor 201 determines the steering angle and the acceleration so that the vehicle 100 does not deviate from the reference route RR when the vehicle 100 is located on the reference route RR, and determines the steering angle and the acceleration so that the vehicle 100 returns to the reference route RR when the vehicle 100 is not located on the reference route RR, in other words, when the vehicle 100 deviates from the reference route RR.

In step 4, the processor 201 of the server 200 transmits the generated travel control signal to the vehicle 100. The processor 201 repeats acquisition of position information of the vehicle 100, determination of a target position, generation of a travel control signal, transmission of a travel control signal, and the like at predetermined intervals.

In step 5, the processor 111 of the vehicle 100 receives the travel control signal transmitted from the server 200. In step 6, the processor 111 of the vehicle 100 controls the actuator group 120 using the received travel control signal, thereby causing the vehicle 100 to travel at the acceleration and the steering angle represented by the travel control signal. The processor 111 repeatedly receives the travel control signal and controls the actuator group 120 at a predetermined cycle. According to the system 50 of the present embodiment, the vehicle 100 can be driven by remote control, and the vehicle 100 can be moved without using a conveyance facility such as a crane or a conveyor.

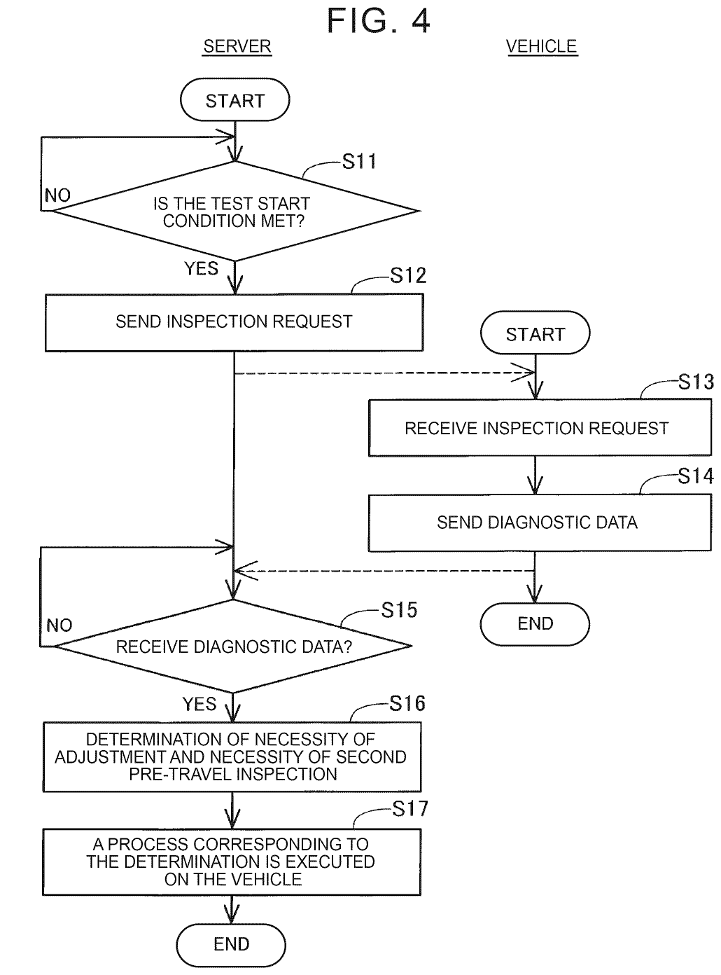

FIG. 4 is a flowchart illustrating a processing procedure in a method of managing a process performed by the server 200. When the vehicles 100 reach the predetermined position P1 in the first location PL1, the process illustrated in FIG. 4 is started. The predetermined position P1 is set in the vicinity of the outlet of the first location PL1 leading to the track TR1 (see FIG. 1). The processor 201 acquires the position information of the vehicle 100 using the captured image acquired from the camera which is the external sensor 300.

In step 11, it is determined whether or not the condition for starting the inspection is satisfied. The process of step 11 is executed by the processor 201 functioning as the acquisition unit 220. The condition for starting the test is, for example, that the assembling process of assembling the components to the vehicles 100 in the first location PL1 is completed. The condition in which the assembling process in the first location PL1 is completed indicates that the vehicles 100 can begin traveling toward the second location PL2. The processor 201 acquires the information of the process performed on the vehicle 100 from the upper server. It is assumed that, after each step is performed, for example, the operator outputs a notification of the end of the step to the higher server using the terminal device. Therefore, the host server has information on the process completed for the vehicle 100. The processor 201 determines whether or not the assembling process in the first location PL1 has been completed based on the process information acquired from the higher-level servers.

If the processor 201 determines that the test starting condition is satisfied (step 11; YES), the process of step 12 is executed. The processor 201 waits until the check starting condition is satisfied (step 11; NO).

In step 12, an inspection request for the first pre-travel inspection is sent to the vehicle 100. The processing of step 12 is executed by the processor 201 functioning as the acquisition unit 220. After turning on the ignition switch of the vehicle 100, the processor 201 transmits an inspection request for the first pre-travel inspection to the vehicle 100. For example, the processor 201 sends a test request to the vehicle 100 instructing to collect diagnostic data for a particular functional unit. Specific functional parts include a steering angle sensor and an electric parking brake (Electronic Parking Brake: EPB). The steering angle sensor detects an angle of a steering wheel provided in the vehicle 100. An electric parking brake is a parking brake that can be activated or deactivated automatically or manually under certain conditions. After the inspection request is transmitted, the process of step 15 described later is executed.

In step 13, the diagnostic data collection unit 140 receives the examination request. In step 14, the diagnostic data collection unit 140 collects diagnostic data corresponding to the examination request, and transmits the diagnostic data to the server 200. For example, when the object specified in the inspection request is an electric parking brake, the diagnostic data collection unit 140 requests the electric parking brake ECU to operate the electric parking brake and to acquire data regarding the operating status of the electric parking brake after the operation. Further, for example, when the object designated in the inspection request is a steering angle sensor, the diagnostic data collection unit 140 acquires data detected by the steering angle sensor. The diagnostic data collection unit 140 transmits the acquired data as diagnostic data to the server 200.

In step 15, it is determined whether the diagnostic data has been received from the vehicle 100. The processing of step 15 is executed by the processor 201 functioning as the acquisition unit 220. Upon receiving the diagnostic data (step 15; YES), the processor 201 executes the process of step 16. The processor 201 waits until it receives diagnostic data from the vehicle 100 in step 15 (step 15; NO).

In step 16, the necessity of adjustment and the necessity of the second pre-travel inspection for the vehicle 100 are determined based on the diagnosis data. Further, in step 16, whether or not the vehicle is allowed to travel is determined based on the diagnosis data. The processing of step 15 is executed by the processor 201 functioning as the determination unit 230. For example, when the detected value of the inspection item in the first pre-travel inspection is less than the predetermined threshold value, it indicates that the vehicle 100 cannot travel. In this case, the travel is determined to be “no”. For example, the fact that the detected value of the inspection item in the first pre-travel inspection is less than the predetermined first reference value indicates that the second pre-travel inspection for the vehicle 100 needs to be performed. In the present embodiment, when the criteria for one or more inspection items of the first pre-travel inspection are not satisfied, the second pre-travel inspection is determined to be “necessary”. Further, for example, the fact that the detected value of the inspection item in the first pre-travel inspection is less than the predetermined second reference value indicates that adjustment to the vehicle 100 is necessary. In this case, the adjustment is determined to be “necessary”. Further, the processor 201 records, in the memory 202, information indicating whether or not the determined travel is possible, whether or not adjustment is necessary, and whether or not the second pre-travel inspection is necessary, in association with the identification information of the vehicle 100. The processing in steps 12 to 16 corresponds to the first pre-travel inspection.

If the diagnostic data indicates that the vehicle 100 is allowed to travel, but that the vehicle 100 needs to be adjusted, the processor 201 determines that the travel is “Yes”, the adjustment is “Needs”, and the second pre-travel inspection is “Needs”.

In addition, when the diagnosis data indicates that the vehicle 100 is allowed to travel and the adjustment of the vehicle 100 is unnecessary, but indicates that the second pre-travel inspection is required, the processor 201 determines that the travel is “available”, the adjustment is “no”, and the second pre-travel inspection is “required”.

When the diagnosis data indicates that the vehicle 100 can travel and the adjustment and the second pre-travel inspection are unnecessary, the processor 201 determines that the travel is “Yes”, the adjustment is “No”, and the second pre-travel inspection is “No”.

When the diagnosis data indicates that the vehicle 100 cannot travel, the processor 201 determines that the travel is “impossible”, the adjustment is “necessary”, and the second pre-travel inspection is “necessary”.

In step 17, a process corresponding to the determination is executed on the vehicle 100. The processing of step 17 is executed by the processor 201 functioning as the management unit 240.

When it is determined that the traveling is “possible”, the adjustment is “necessary”, and the second pre-traveling inspection is “necessary”, the processor 201 notifies the operator via the terminal device of the fact that the adjustment of the vehicle 100 is necessary together with the identification information of the vehicle 100. The operator who has received the notification performs the required adjustment using, for example, a function of an in-vehicle failure diagnosis (On-board diagnostics: OBD) included in the vehicle 100. When the necessary adjustment is completed, the operator notifies the processor 201 that the adjustment is completed via the terminal device. Thereafter, the processor 201 generates a travel control signal for controlling the actuator group 120, and transmits a travel control signal to the vehicle 100 to cause the vehicle 100 to travel toward the second location PL2 by remote control. The process of moving the vehicles 100 toward the second location PL2 by remote control is also referred to as a “moving process”.

When it is determined that the traveling is “possible”, the adjustment is “no”, and the second pre-traveling inspection is “necessary”, the processor 201 causes the vehicle 100 to start traveling by remote control. Also, in a case where it is determined that the traveling is “possible”, the adjustment is “no”, and the second pre-traveling inspection is “no”, the processor 201 causes the vehicle 100 to start traveling by remote control.

When it is determined that the traveling is “impossible”, the adjustment is “necessary”, and the second pre-traveling inspection is “necessary”, the processor 201 notifies the operator via the terminal device of the identification information of the vehicle 100 that the vehicle 100 is impossible to travel. The operator who has received the notification can perform the necessary treatment on the vehicle 100. Further, the processor 201 notifies the upper server of the fact that the vehicle 100 cannot travel together with the identification information of the vehicle 100. The above is a series of processes related to the first pre-travel inspection.

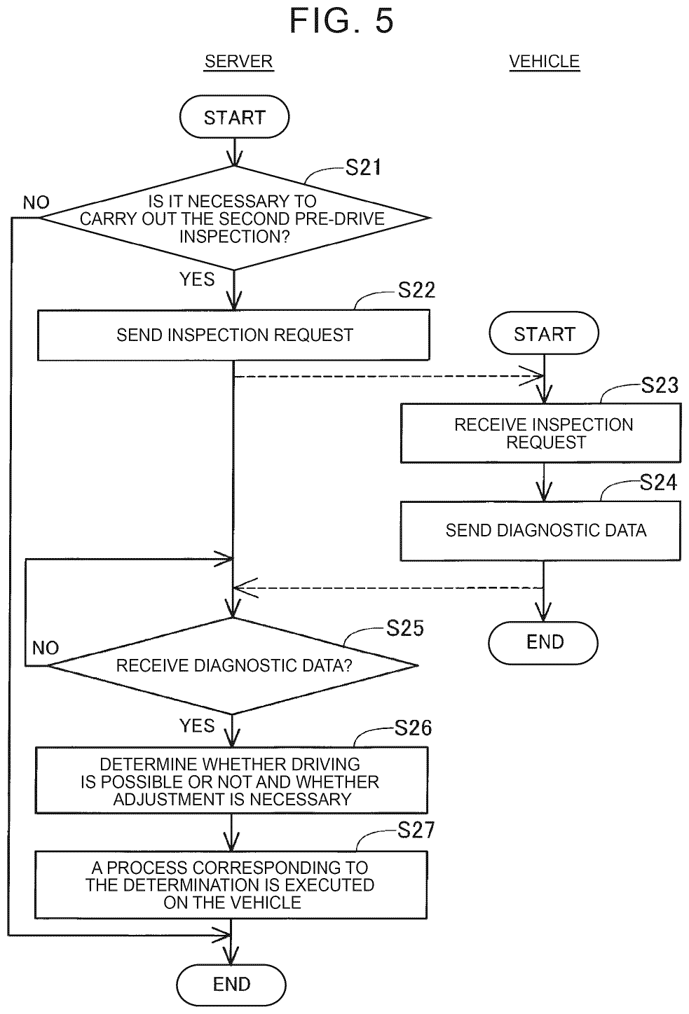

FIG. 5 is a flowchart illustrating a processing procedure related to the second pre-travel inspection. When the vehicles 100 reach the predetermined position P2 in the second location PL2, the process illustrated in FIG. 5 is started. The predetermined position P2 is set in the vicinity of the outlet of the second location PL2 leading to the track TR2 (see FIG. 1). The processor 201 acquires the position information of the vehicle 100 using the captured image acquired from the camera which is the external sensor 300.

As illustrated in FIG. 5, in step 21, it is determined whether or not the second pre-travel inspection is necessary. The processing of step 21 is executed by the processor 201 functioning as the management unit 240. The content of the necessity of the second pre-travel inspection is determined at the time of execution of the first pre-travel inspection, and is recorded in the memory 202 (see step 16 in FIG. 4).

When the second pre-travel test needs to be performed (step 21; YES), the process of step 22 is performed. When it is not necessary to perform the second pre-travel test (step 21; NO), the process illustrated in FIG. 5 is terminated. After the process illustrated in FIG. 5 is completed, the processor 201 designates the third location PL3 as a destination, and causes the vehicles 100 to start traveling by remote control.

In step 22, an inspection request for the second pre-travel inspection is sent to the vehicle 100. The processing of step 22 is executed by the processor 201 functioning as the acquisition unit 220. Specifically, first, the processor 201 determines, prior to the transmission of the inspection request for the second pre-travel inspection, whether or not the inspection start condition is satisfied based on the process information acquired from the higher-level server. The condition for starting the test is, for example, that the assembling process of assembling the components to the vehicles 100 in the second location PL2 is completed. The condition in which the assembling process in the second location PL2 is completed indicates that the vehicle 100 can begin traveling from the second location PL2 toward the third location PL3.

When determining that the inspection start condition is satisfied based on the process information, the processor 201 turns on the ignition switch of the vehicle 100, and then transmits an inspection request for the second pre-travel inspection to the vehicle 100. For example, the processor 201 transmits, as the second pre-travel inspection, an inspection request instructing the vehicle 100 to collect diagnostic data for a specific functional unit.

In step 23, the diagnostic data collection unit 140 receives the examination request. In step 24, the diagnostic data collection unit 140 collects diagnostic data corresponding to the examination request, and transmits the diagnostic data to the server 200. For example, when the object specified in the inspection request is an electric parking brake, the diagnostic data collection unit 140 requests the electric parking brake ECU to operate the electric parking brake and to acquire data regarding the operating status of the electric parking brake after the operation. Further, for example, when the object designated in the inspection request is a steering angle sensor, the diagnostic data collection unit 140 acquires data detected by the steering angle sensor. The diagnostic data collection unit 140 transmits the acquired data as diagnostic data to the server 200.

In step 25, it is determined whether the diagnostic data has been received from the vehicle 100. The processing of step 25 is executed by the processor 201 functioning as the acquisition unit 220. Upon receiving the diagnostic data (step 25; YES), the processor 201 executes the process of step 26. In step 25, the processor 201 waits while the diagnostic data is not being received (step 25; NO).

In step 26, whether or not the vehicle 100 is allowed to travel and whether or not adjustment is required is determined based on the diagnosis data. The processing of step 126 is executed by the processor 201 functioning as the determination unit 230. Further, the processor 201 records information indicating whether or not the determined travel is possible and whether or not the adjustment is necessary in the memory 202 in association with the identification information of the vehicle 100. The processing in steps 22 to 26 corresponds to the second pre-travel inspection.

If the diagnostic data indicates that the vehicle 100 is allowed to travel, but that adjustment of the vehicle 100 is required, the processor 201 determines that the travel is “good” and the adjustment is “required.” In addition, when the diagnosis data indicates that the vehicle 100 is allowed to travel and the adjustment of the vehicle 100 is unnecessary, the processor 201 determines that the travel is “acceptable” and the adjustment is “no”.

When the diagnosis data indicates that the vehicle 100 cannot travel, the processor 201 determines that the travel is “not possible” and the adjustment is “necessary”.

In step 27, processing according to the determination is performed on the vehicle 100. The processing of step 27 is executed by the processor 201 functioning as the management unit 240.

When it is determined that the driving is “possible” and the adjustment is “necessary”, the processor 201 notifies the operator via the terminal device of the fact that the adjustment of the vehicle 100 is necessary together with the identification information of the vehicle 100. The operator who has received the notification performs the necessary adjustment on the vehicle 100.

If the driving is determined to be “possible” and the adjusting is determined to be “not”, the processor 201 sets the third location PL3 as a destination, and causes the vehicles 100 to start the driving by remote control.

When it is determined that the traveling is “impossible” and the adjustment is “necessary”, the processor 201 notifies the operator of the fact that the vehicle 100 cannot travel together with the identification information of the vehicle 100 via the terminal device. The operator who has received the notification can perform the necessary treatment on the vehicle 100. Further, the processor 201 notifies the upper server of the fact that the vehicle 100 cannot travel together with the identification information of the vehicle 100. The above is a series of processes related to the second pre-travel inspection.

In the present embodiment, before the vehicle 100 in the form of a platform starts traveling, it is necessary to perform an inspection (a first pre-traveling inspection) of whether or not the necessary conditions for the vehicle 100 to travel are satisfied. Further, before the vehicle 100 in the form of a completed vehicle starts traveling, it is necessary to perform an inspection (inspection before the second traveling) as to whether or not the necessary conditions for the vehicle 100 to travel are satisfied. In a case where the same inspection item as the inspection item included in the first pre-travel inspection is included in the second pre-travel inspection, the inspection for the same inspection item is executed twice.

Therefore, in the present embodiment, when the second pre-travel inspection can be omitted according to the result of the first pre-travel inspection, the repeated inspection is omitted. When the adjustment can be omitted, the execution of the adjustment is omitted. If possible, the man-hours can be reduced by omitting the adjustment and the execution of the second pre-travel inspection. Therefore, it is possible to improve the efficiency of the manufacturing process. In addition, since the execution of the second pre-travel inspection is omitted in a case where the execution of the second pre-travel inspection can be omitted based on the result of the first pre-travel inspection, it is possible to achieve both the maintenance of the quality and the efficiency improvement of the manufacturing process.

### B. Second Embodiment

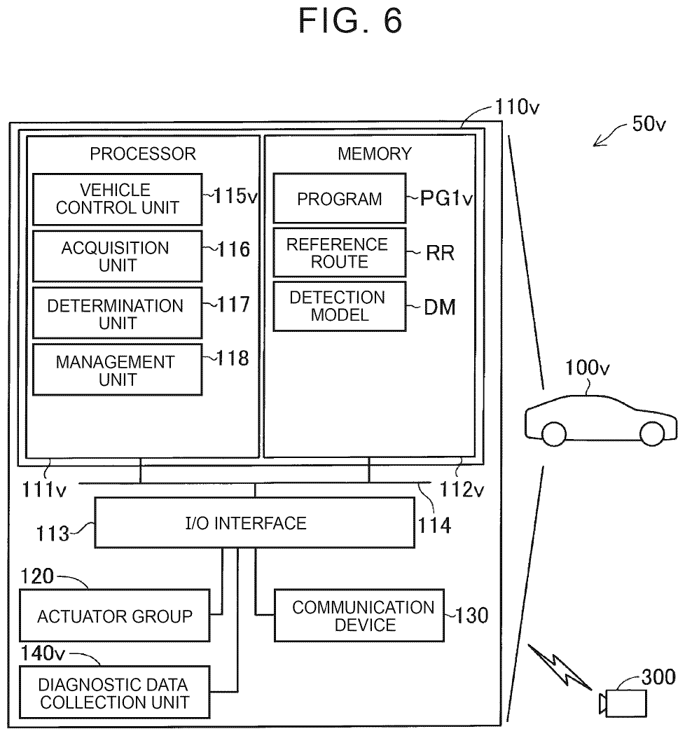

FIG. 6 is an explanatory diagram illustrating a schematic configuration of a system 50v according to the second embodiment. This embodiment differs from the first embodiment in that the system 50v does not include the servers 200. Further, the vehicle 100v according to the present embodiment can travel by autonomous control of the vehicle 100v. Other configurations are the same as those of the first embodiment unless otherwise described.

In the present embodiment, the processor 111v of the vehicle control device 110v functions as the vehicle control unit 115v, the acquisition unit 116, the determination unit 117, and the management unit 118 by executing the program PG1v stored in the memory 112v.

The vehicle control unit 115v can cause the vehicle 100v to travel by autonomous control by acquiring an output result from the sensor, generating a travel control signal using the output result, and outputting the generated travel control signal to operate the actuator group 120. In the present embodiment, in addition to the program PG1v, the detection model DM and the reference route RR are stored in advance in the memory 112v.

The acquisition unit 116 acquires data collected by the diagnostic data collection unit 140v. The determination unit 117 determines whether the adjustment is necessary and whether the second pre-travel inspection is necessary, using the data collected by the diagnostic data collection unit 140v. The management unit 118 manages the adjustment, the execution of the second pre-travel inspection, and the moving process of the vehicle 100 in accordance with the determination by the determination unit 230.

The diagnostic data collection unit 140v has the same function as the diagnostic data collection unit 140 in the first embodiment.

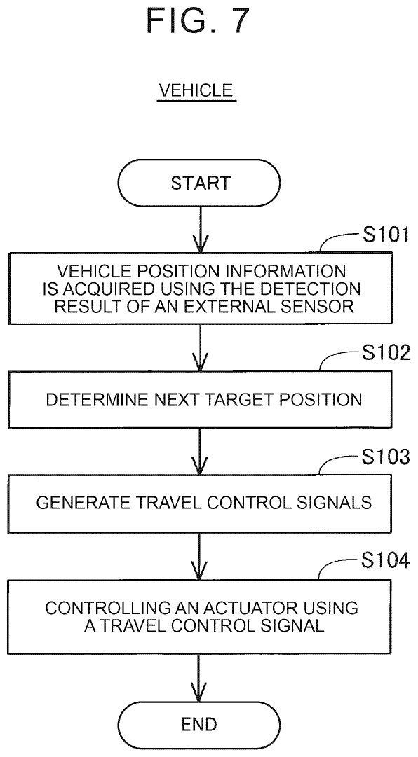

FIG. 7 is a flow chart showing a process sequence of travel control of the vehicle 100v according to the second embodiment. The process of FIG. 7 is executed by the processor 111v of the vehicle 100v functioning as the vehicle control unit 115v.

In step 101, the processor 111v of the vehicle control device 110v acquires the vehicle position information using the detection result outputted from the camera as the external sensor 300. At step 102, the processor 111v determines a target position to which the vehicle 100v should be headed next. In step 103, the processor 111v generates a travel control signal for causing the vehicle 100v to travel toward the determined target position. In step 104, the processor 111v controls the actuator group 120 using the generated travel control signal to cause the vehicle 100v to travel in accordance with the parameter represented by the travel control signal. The processor 111v repeats acquiring the vehicle position information, determining the target position, generating the travel control signal, and controlling the actuator at a predetermined cycle. According to the system 50v of the present embodiment, the vehicle 100v can be driven by the autonomous control of the vehicle 100v without remotely controlling the vehicle 100v by the servers 200.

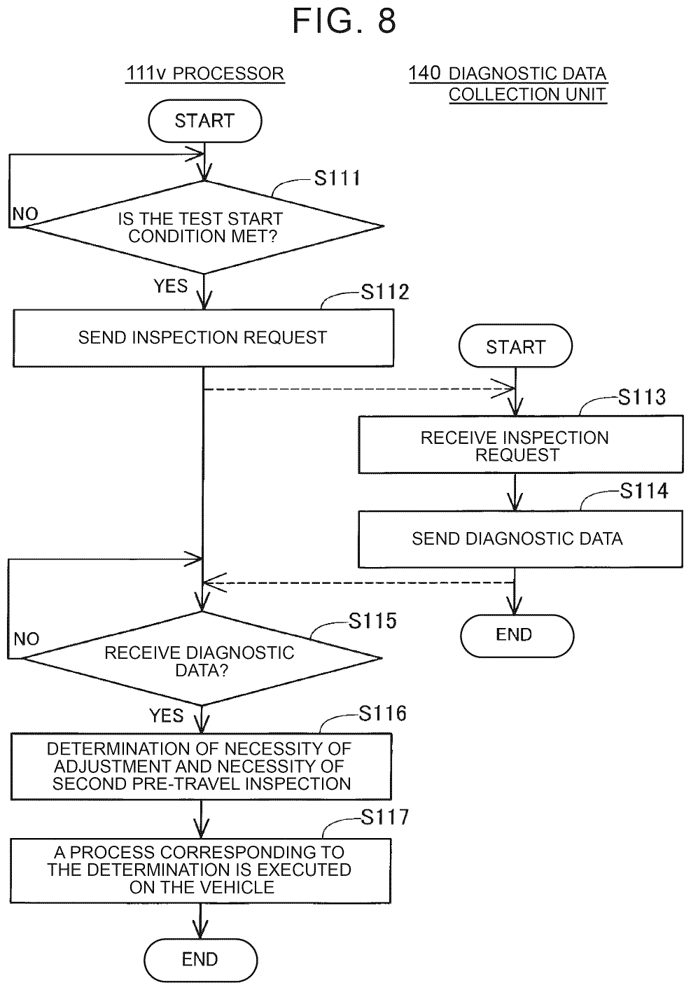

FIG. 8 is a flowchart illustrating a processing procedure according to the first pre-travel inspection. When the vehicle 100v reaches the position P1 in the first location PL1 (see FIG. 1), the process illustrated in FIG. 8 is started. The processor 111v acquires the position data of the vehicles 100 using the captured images acquired from the cameras that are the external sensors 300.

In step 111, it is determined whether or not the condition for starting the test is satisfied. The process of step 111 is executed by the processor 111v functioning as the acquisition unit 116. The condition for starting the test is, for example, that the assembly process in the first location PL1 is completed. The processor 111v acquires the process performed on the vehicles 100 from the higher-level servers. The processor 111v determines whether or not the assembling process in the first location PL1 has been completed based on the process information acquired from the higher-level servers.

If the processor 111v determines that the check starting condition is satisfied (step 111; YES), the process of step 112 is executed. The processor 111v waits until the check start-condition is met (step 111; NO).

In step 112, a test request for the first pre-travel test is sent to the diagnostic data collection unit 140v. The process of step 112 is executed by the processor 111v functioning as the acquisition unit 116. After turning on the ignition switch of the vehicle 100, the processor 111v transmits an inspection request for the first pre-travel inspection to the diagnostic data collection unit 140v. For example, the processor 201 transmits, as the first pre-travel inspection, an inspection request instructing to inspect a particular functional unit to the diagnostic data collection unit 140v. After the inspection request is transmitted, the process of step 115 described later is executed.

In step 113, the diagnostic data collection unit 140v receives a test request. In step 114, the diagnostic data collection unit 140v transmits, as diagnostic data, the data collected from ECU that controls the object specified in the test request to the processor 111v.

In step 115, it is determined whether diagnostic data has been received. The process of step 115 is executed by the processor 111v functioning as the acquisition unit 116. When the processor 111v receives the diagnostic data (step 115; YES), the process of step 116 is executed. In step 15, the processor 111v waits until the diagnostic data is received (step 115; NO).

In step 116, 100v of vehicles is adjusted and the need for a second pre-travel test is determined based on the diagnostic data. Further, in step 116, whether or not the vehicle is allowed to travel is determined based on the diagnosis data. The process of step 116 is executed by the processor 111v functioning as the determination unit 117. In addition, the processor 111v records the determined traveling availability, the necessity of adjusting, and the information indicating the necessity of the second pre-traveling inspection in the memory 112v. The processing from step 112 to step 116 corresponds to the first pre-travel inspection.

In step 117, a process responsive to the determination is performed on the vehicle 100. The process of step 17 is executed by the processor 111v functioning as the management unit 118. The processing executed in response to the determination is the same as that of the first embodiment. The above is a series of processes related to the first pre-travel inspection.

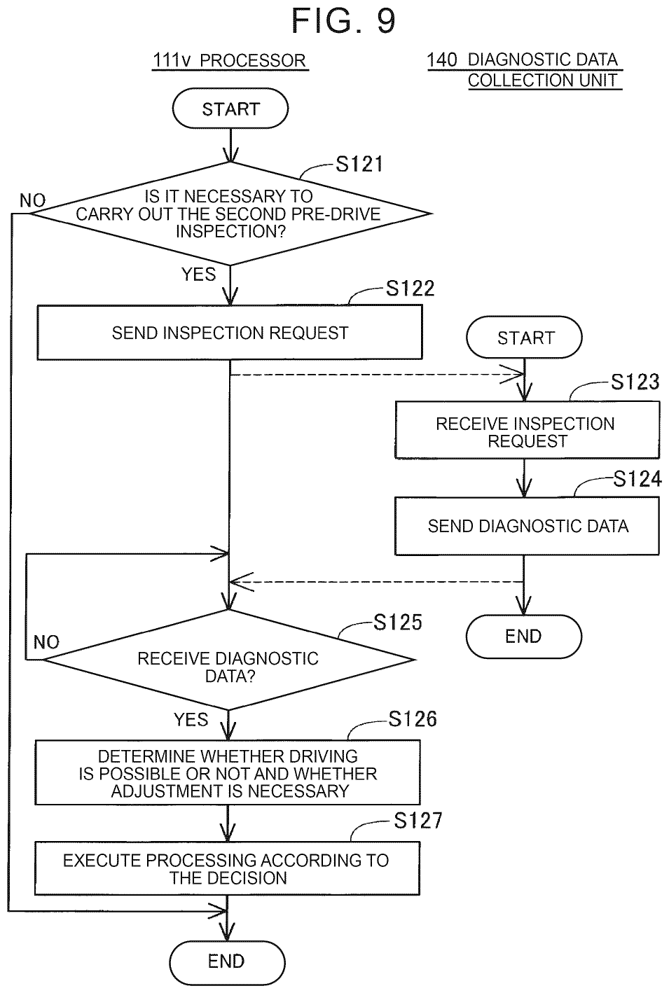

FIG. 9 is a flowchart illustrating a processing procedure related to the second pre-travel inspection. When the vehicles 100 reach the predetermined position P2 in the second location PL2 (see FIG. 1), the process illustrated in FIG. 9 is started. The processor 111v acquires the position data of the vehicle 100v using the captured images acquired from the cameras that are the external sensors 300.

As illustrated in FIG. 9, in step 121, it is determined whether or not the second pre-travel inspection is necessary. The process of step 121 is executed by the processor 111v functioning as the management unit 118. The content of the necessity of the second pre-travel inspection is determined at the time of execution of the first pre-travel inspection, and is recorded in the memory 202 (see step 116 in FIG. 8).

When the second pre-travel test needs to be performed (step 121;YES), the process of step 122 is performed. When it is not necessary to perform the second pre-travel test (step 121; NO), the process illustrated in FIG. 9 is ended. After the process illustrated in FIG. 9 is completed, the processor 111v sets the third location PL3 as a destination, and starts traveling of the vehicles 100 by autonomous control.

In step 122, a test request for the second pre-travel test is sent to the diagnostic data collection unit 140v. The process of step 122 is executed by the processor 111v functioning as the acquisition unit 116. Specifically, first, the processor 111v determines whether or not the test start condition is satisfied based on the process information acquired from the higher-level servers, prior to transmitting the test request for the second pre-travel test. The condition for starting the test is, for example, that the assembling process in the second location PL2 is completed. The condition in which the assembling process in the second location PL2 is completed indicates that the vehicle 100 can begin traveling from the second location PL2 toward the third location PL3.

When the processor 111v determines that the test start condition is satisfied based on the process information, it turns on the ignition switch of the vehicle 100 and then transmits a test request for the second pre-travel test to the diagnostic data collection unit 140v. For example, the processor 111v transmits, as the second pre-travel inspection, an inspection request instructing to inspect a particular functional unit to the diagnostic data collection unit 140v.

In step 123, the diagnostic data collection unit 140v receives a test request. In step 124, the diagnostic data collection unit 140v collects diagnostic data in response to the examination request, and transmits the diagnostic data to the processor 111v.

In step 125, it is determined whether or not the diagnostic data has been received from the diagnostic data collection unit 140v. The process of step 125 is executed by the processor 111v functioning as the acquisition unit 116. Upon receiving the diagnostic data (step 125; YES), the processor 111v executes the process of step 126. In step 125, the processor 111v waits while no diagnostic data is received (step 125; NO).

In step 126, whether or not the vehicle 100 is allowed to travel and whether or not adjustment is required is determined based on the diagnosis data. The process of step 126 is executed by the processor 111v functioning as the determination unit 117. The processing in steps 122 to 126 corresponds to the second pre-travel inspection.

If the diagnostic data indicates that the vehicle 100 is allowed to travel, but the vehicle 100 needs to be adjusted, the processor 111v determines that the travel is “good” and the adjustment is “required.” When the diagnostic data indicates that the vehicle 100 is capable of traveling and the adjustment of the vehicle 100 is not necessary, the processor 111v determines that the traveling is “possible” and the adjustment is “no”.

In addition, when the diagnostic data indicates that the vehicle 100 cannot travel, the processor 111v determines that the travel is “not possible” and the adjustment is “required”.

In step 127, a process responsive to the determination is performed on the vehicle 100. The process of step 127 is executed by the processor 111v functioning as the management unit 118.

In the present embodiment, as in the first embodiment, when the second pre-travel inspection can be omitted according to the result of the first pre-travel inspection, the second pre-travel inspection is omitted. When the adjustment can be omitted, the execution of the adjustment is omitted. If possible, the man-hours can be reduced by omitting the adjustment and the execution of the second pre-travel inspection. Therefore, it is possible to improve the efficiency of the manufacturing process. In addition, since the execution of the second pre-travel inspection is omitted in a case where the execution of the second pre-travel inspection can be omitted based on the result of the first pre-travel inspection, it is possible to achieve both the maintenance of the quality and the efficiency improvement of the manufacturing process.

### C. Other Embodiments

(C1) In the first embodiment, the server 200 automatically generates a travel control signal to be transmitted to the vehicle 100. On the other hand, the server 200 may generate a travel control signal to be transmitted to the vehicle 100 in accordance with an operation of an external operator located outside the vehicle 100. For example, an external operator may operate a control device including a display for displaying a captured image output from the external sensor 300, a steering wheel for remotely controlling the vehicle 100, an accelerator pedal, a brake pedal, and a communication device for communicating with the server 200 through wired communication or wireless communication, and the server 200 may generate a travel control signal corresponding to an operation applied to the control device.

As in the first embodiment, the server 200 cooperates with the diagnostic data collection unit 140 to acquire diagnostic data. The server 200 determines whether or not adjustment is necessary and whether or not the second pre-travel inspection is necessary based on the diagnosis data. Further, the server 200 performs or does not perform the adjustment, and performs or does not perform the second pre-travel inspection, depending on the determined content.

(C2) In the first embodiment and the second embodiment described above, an example has been described in which the first pre-travel inspection may be performed on the vehicle 100 in the state of the platform, and the second pre-travel inspection may be performed on the vehicle 100 in the state of the completed vehicle. However, it is not limited thereto.

The first pre-travel inspection may be performed after the interior components are mounted on the vehicle 100 in the state of the platform. Alternatively, the first pre-travel inspection may be performed after a part or all of the interior parts and the exterior parts are mounted on the vehicle 100 in the state of the platform. The second pre-travel inspection may be performed on the vehicle 100 that is not in the state of the completed vehicle.

(C3) In addition to the first pre-travel inspection and the second pre-travel inspection, the third pre-travel inspection may be performed at the third location PL3. The third pre-travel inspection shall include the same inspection items as the inspection items included in the second pre-travel inspection. In this case, the necessity of adjustment and the necessity of execution of the third pre-travel inspection performed after the second pre-travel inspection are determined based on the result of the second pre-travel inspection. The objects of the second pre-travel inspection and the third pre-travel inspection are the vehicles 100 in the state of the completed vehicles. In other words, the vehicle 100 at the time of performing the third pre-travel inspection is in a state in which no new component is assembled after the second pre-travel inspection. The second pre-travel inspection is also referred to as “first processing”, and the third pre-travel inspection is also referred to as “second processing”.

Alternatively, the necessity of adjustment and the necessity of execution of the third pre-travel inspection may be determined based on the result of the first pre-travel inspection. In this case, it is assumed that the third pre-travel inspection includes the same inspection item as the inspection item included in the first pre-travel inspection. The first pre-travel inspection is also referred to as “first processing”, and the third pre-travel inspection is also referred to as “second processing”.

Alternatively, the necessity of performing the third pre-travel inspection may be determined based on the result of the first pre-travel inspection and the result of the second pre-travel inspection. In this case, the third pre-travel inspection includes the same inspection item as the inspection item included in the first pre-travel inspection. The necessity of adjustment after the first pre-travel inspection is determined in accordance with the result of the first pre-travel inspection, and the necessity of adjustment after the second pre-travel inspection is determined in accordance with the result of the second pre-travel inspection. The first pre-travel inspection and the second pre-travel inspection are also referred to as “first processing”, and the third pre-travel inspection is also referred to as “second processing”.

(C4) In the first embodiment and the second embodiment, the function of the diagnostic data collection unit 140 is realized by a diagnostic ECU. However, the functions of the diagnostic data collection unit 140 may be implemented by the processor 111 or the processor 111v. Alternatively, the functions of the diagnostic data collection unit 140 may be implemented by respective ECU, such as a motor control ECU, a transmission ECU, a brake ECU, or an electric parking brake ECU.

(C5) In each of the above-described embodiments, it is determined whether or not to perform the second pre-travel inspection based on the result of the first pre-travel inspection. Alternatively, the necessity of execution of each of the corresponding inspection items in the second pre-travel inspection may be determined based on the result of each of the inspection items in the first pre-travel inspection. In this case as well, if possible, the execution of duplicate inspection items is omitted, and thus the number of man-hours can be reduced. In addition, even if the inspection items are duplicated in the first pre-travel inspection and the second pre-travel inspection, the inspection items are performed twice when necessary. Therefore, it is possible to achieve both maintenance of quality and efficiency improvement of the manufacturing process.

(C6) In the above embodiments, an example in which the diagnosis data is acquired via the diagnostic data collection unit 140 of the vehicle 100 has been described. Alternatively, the processor 201 or the processor 111v may determine the angle of the tire using images captured by the camera, which is the external sensor 300, of the vehicle 100 while the steering wheel of the vehicle 100 is being operated, for example. The accuracy of the steering angle sensor can be inspected by comparing the obtained angle with the detection value of the steering angle sensor.

(C7) In the first embodiment, the communication device 130 is a radio communication device connected to a DLC provided in the vehicle 100. Alternatively, the device may be a device that enables radio communication between Controller Area Network (CAN) and the servers 200.

(C8) In the first embodiment, the first pre-travel inspection and the second pre-travel inspection are performed on the vehicle 100 that is stopped. However, in a case where the inspection item requires the vehicle 100 to travel, the server 200 may cause the vehicle 100 to travel a certain distance by remote control. The same applies to a vehicle 100v traveling by autonomous control.

(C9) In the first embodiment described above, the vehicle 100 travels to the second location PL2 after the first pre-travel test is performed. However, after the first pre-travel inspection is performed, the vehicle 100 may not travel to the second location PL2, that is, the vehicle 100 in the form of a platform while the vehicle 100 remains at the first location PL1, and exterior components such as a body shell, a vehicle body such as a bonnet, a seat, an interior component such as a dashboard, a bumper, a fender, and the like may be assembled by an assembly robot (not shown).

Further, in the first embodiment described above, after the first pre-travel inspection is performed and before the assembling process is performed in the second location PL2, the adjusting is performed when required. However, after the first pre-travel inspection is performed, the vehicles 100 may be moved to the second location PL2, and after the assembling process in the second location PL2 is performed, the adjusting may be performed when needed.

(C10) In each of the above-described embodiments, the external sensor 300 is not limited to a camera, and may be, for example, a distance measuring device. The distance measuring device is, for example, a Light Detection And Ranging (LiDAR). In this case, the detection result output by the external sensor 300 may be three-dimensional point cloud data representing the vehicle 100. In this case, the server 200 or the vehicle 100 may acquire the vehicle position information by template matching using three-dimensional point cloud data as a detection result and reference point cloud data prepared in advance.

(C11) In the first embodiment, the server 200 executes processing from acquisition of vehicle position information to generation of a travel control signal. On the other hand, at least a part of the processing from the acquisition of the vehicle position information to the generation of the travel control signal may be executed by the vehicle 100. For example, the following forms (1) to (3) may be used.

(1) The server 200 may acquire the vehicle position information, determine a target position to which the vehicle 100 should be heading next, and generate a route from the current position of the vehicle 100 represented by the acquired vehicle position information to the target position. The server 200 may generate a route to a target position between the current location and the destination, or may generate a route to the destination. The server 200 may transmit the generated route to the vehicle 100. The vehicle 100 may generate a travel control signal so that the vehicle 100 travels on the route received from the server 200, and control the actuator group 120 using the generated travel control signal.

(2) The server 200 may acquire the vehicle position information and transmit the acquired vehicle position information to the vehicle 100. The vehicle 100 may determine a target position to which the vehicle 100 should be directed next, generate a route from the current position of the vehicle 100 represented by the received vehicle position information to the target position, generate a travel control signal so that the vehicle 100 travels on the generated route, and control the actuator group 120 using the generated travel control signal.

(3) In the above forms (1) and (2), an internal sensor may be mounted on the vehicle 100, and a detection result output from the internal sensor may be used for at least one of generation of a route and generation of a travel control signal. The internal sensor is a sensor mounted on the vehicle 100. The internal sensor may include, for example, a sensor that detects a motion state of the vehicle 100, a sensor that detects an operation state of each unit of the vehicle 100, and a sensor that detects an environment around the vehicle 100. Specifically, the inner sensor may include, for example, a camera, a LiDAR, a millimeter-wave radar, an ultrasonic sensor, a GPS sensor, an accelerometer, a gyroscope, and the like. For example, in the form (1), the server 200 may acquire the detection result of the internal sensor and reflect the detection result of the internal sensor in the path when generating the path. In the form (1), the vehicle 100 may acquire the detection result of the internal sensor and reflect the detection result of the internal sensor in the travel control signal when generating the travel control signal. In the form (2), the vehicle 100 may acquire the detection result of the internal sensor and reflect the detection result of the internal sensor in the path when generating the path. In the form (2), the vehicle 100 may acquire the detection result of the internal sensor and reflect the detection result of the internal sensor in the travel control signal when generating the travel control signal.

(C12) In the second embodiment, an internal sensor may be mounted on the vehicle 100v, and a detection result outputted from the internal sensor may be used for at least one of generation of a route and generation of a travel control signal. For example, the vehicle 100v may acquire the detection result of the internal sensor and reflect the detection result of the internal sensor in the route when generating the route. The vehicle 100v may acquire the detection result of the internal sensor and reflect the detection result of the internal sensor in the travel control signal when generating the travel control signal.

(C13) In the second embodiment, the vehicle 100v acquires the vehicle position information using the detection result of the external sensor 300. On the other hand, an internal sensor is mounted on the vehicle 100v, and the vehicle 100v may acquire the vehicle position information using the detection result of the internal sensor, determine a target position to which the vehicle 100v should be directed next, generate a route from the current position of the vehicle 100v represented in the acquired vehicle position information to the target position, generate a travel control signal for traveling on the generated route, and control the actuator group 120 using the generated travel control signal. In this case, the vehicle 100v can travel without using the detection result of the external sensor 300 at all. The vehicle 100v may acquire the target arrival time and the traffic jam information from the outside of the vehicle 100v and reflect the target arrival time and the traffic jam information on at least one of the route and the travel control signal. In addition, all the functional configurations of the system 50v may be provided in the vehicle 100v. That is, the process implemented by the system 50v may be implemented by the vehicle 100v alone.

(C14) The vehicle 100 may be manufactured by combining a plurality of modules. A module refers to a unit composed of one or more components grouped according to the configuration and function of the vehicle 100. For example, the platform of the vehicle 100 may be manufactured by combining a front module that constitutes a front portion of the platform, a central module that constitutes a central portion of the platform, and a rear module that constitutes a rear portion of the platform. The number of modules constituting the platform is not limited to three, and may be two or less or four or more. In addition to or instead of the platform, a different part of the vehicle 100 from the platform may be modularized. Further, the various modules may include any exterior parts such as bumpers and grills, and any interior parts such as sheets and consoles. In addition, not only the vehicle 100 but also a mobile body of an arbitrary mode may be manufactured by combining a plurality of modules. Such a module may be manufactured, for example, by joining a plurality of parts by welding, a fixture, or the like, or may be manufactured by integrally molding at least a part of the module as one part by casting. Molding techniques for integrally molding at least a portion of a module as one part are also referred to as gigacasts or megacasts. By using the gigacast, each part of the mobile body, which has been conventionally formed by joining a plurality of parts, can be formed as one part. For example, the front module, the central module, and the rear module described above may be manufactured using gigacast.

(C15) Transporting the vehicle 100 by using the traveling of the vehicle 100 by the unmanned driving is also referred to as “self-propelled conveyance”. A configuration for realizing self-propelled conveyance is also referred to as a “vehicle remote control autonomous traveling conveyance system”. Further, a production method of producing the vehicle 100 by using self-propelled conveyance is also referred to as “self-propelled production”. In self-propelled manufacturing, for example, at least a part of conveyance of the vehicle 100 is realized by self-propelled conveyance in a factory FC that manufactures the vehicle 100.

(C16) In each of the above-described embodiments, some or all of the functions and processes implemented in software may be implemented in hardware. In addition, some or all of the functions and processes implemented in hardware may be implemented in software. For example, various circuits such as an integrated circuit and a discrete circuit may be used as hardware for realizing various functions in the above-described embodiments.

The present disclosure is not limited to each of the above embodiments, and can be realized by various configurations without departing from the spirit thereof. For example, the technical features in the embodiments corresponding to the technical features in the respective embodiments described in the summary column of the disclosure can be appropriately replaced or combined in order to solve the above-described problem or to achieve some or all of the above-described effects. In addition, if the technical features are not described as being essential in the present specification, they can be deleted as appropriate.

What is claimed is:

1. A control device that manages a process for a mobile body manufactured through a plurality of processes, the control device comprising:
an acquisition unit that acquires information that indicates a state of the mobile body;
a determination unit that makes a determination as to necessity of adjustment and necessity of a second process according to a result of a first process performed using the information; and
a management unit that performs or does not perform the adjustment and performs or does not perform the second process according to the determination, wherein:
the processes include the first process related to inspection, an assembly process, the adjustment, and the second process;
the assembly process is a process performed after the first process to assemble a component to the mobile body;
the adjustment is performed after the first process or the assembly process; and
the second process is a process related to inspection and performed after the assembly process or the adjustment.

2. The control device according to claim 1, wherein:
the first process is performed on the mobile body in a state of a platform; and
the second process is performed on the mobile body in a state of a finished vehicle.

3. The control device according to claim 2, wherein the second process includes inspection that is the same as inspection included in the first process.

4. The control device according to claim 3, wherein:
the mobile body is a mobile body that travels in a factory in which the processes are performed;
the processes further include a moving process performed after the first process or the assembly process to move the mobile body; and
the management unit performs the moving process with or without performing the adjustment and with or without performing the second process according to the determination.

5. A method of managing a process for a mobile body manufactured through a plurality of processes, the processes including a first process related to inspection, an assembly process performed after the first process to assemble a component to the mobile body, adjustment performed after the first process or the assembly process, and a second process related to inspection and performed after the assembly process or the adjustment, the method comprising:
acquiring information that indicates a state of the mobile body;
making a determination as to necessity of the adjustment and necessity of the second process according to a result of the first process performed using the information; and
performing or not performing the adjustment and performing or not performing the second process according to the determination, wherein:
the processes include the first process related to inspection, an assembly process, the adjustment, and the second process;
the assembly process is a process performed after the first process to assemble a component to the mobile body;
the adjustment is performed after the first process or the assembly process; and
the second process is a process related to inspection and performed after the assembly process or the adjustment.
